(19) United States
(12) Patent Application Publication
(10) Pub. No.: US 2012/0264361 A1
(43) Pub. Date: Oct. 18, 2012

(54) PROCESS AND APPARATUS FOR IMPROVING THE QUALITY OF THE AIR IN A VEHICLE INTERIOR

(75) Inventors: Volker Scheer, Roetgen (DE); Achim Dr Lindner, Euskirchen (DE); Rainer Vogt, Aachen (DE)

(73) Assignee: FORD GLOBAL TECHNOLOGIES, LLC, Dearborn, MI (US)

(21) Appl. No.: 13/430,767

(22) Filed: Mar. 27, 2012

(30) Foreign Application Priority Data
Apr. 14, 2011 (DE) 102011007351.5

(51) Int. Cl. B60H 1/24

(52) U.S. Cl. 454/75; 454/139; 454/156; 454/158

(57) ABSTRACT

A process for improving the quality of air in a vehicle interior is provided in which an air cleaning device is activated during a parked state of the vehicle, and an air freshening device is activated on the basis of a signal for ending the parked state. An apparatus for improving the quality of the air in a vehicle interior is also provided.

### FIELD OF THE INVENTION

The present invention generally relates to improved air quality for a vehicle, and more particularly to a process and apparatus for improving the air quality in the vehicle interior.

### BACKGROUND OF THE INVENTION

When a vehicle is parked for a prolonged period, the air in a vehicle interior is typically enriched by outgases from the surfaces in the vehicle interior, such as outgases from the materials forming the interior trim of the vehicle and from other materials in the vehicle interior or even from dirt, and by gases and aerosols generated by the activity of organisms, especially microorganisms. These constituents of the air include, in particular, hydrocarbons from the materials used to make the interior trim.

The unwanted constituents of the air in the vehicle interior are generally detected by an unpleasant smell. Such a smell is particularly noticeable when people get into a vehicle that has been parked for a prolonged period since the people entering the vehicle are then used to the fresh air outside the vehicle, and the concentration of unwanted constituents of the air in the interior of the vehicle has increased to a particularly high level after prolonged parking. The vehicle occupants are likewise exposed to the germs on the surfaces which are usually touched by a user of the vehicle, e.g. on the steering wheel, the gear lever or the door handles.

In order to mitigate the unpleasant smell, the windows can be opened, leading to a rapid air exchange with the ambient air. However, there is no air exchange if the air is not in motion. Opening the windows while traveling is not always desired or possible, depending on the weather conditions and the driving situation. Moreover, operating the ventilating system after the passengers have entered the vehicle is in any case not a suitable way of eliminating the unpleasant smell experienced upon entry.

The proposal in U.S. Pat. No. 7,013,656 B2 is therefore to activate a ventilating function of the air conditioning system of a parked vehicle when a signal for unlocking the doors is received. In this case, either outside air is blown into the interior of the vehicle or the inside air is cleaned by means of a filter. According to JP 0 622 724 8 A, a fragrance or deodorant is fed to the vehicle interior by means of a ventilating system of the vehicle after the reception of a door opening signal. However, the time available between the reception of the door unlocking or door opening signal and the entry of the occupants is often too short to eliminate the unpleasant smell; moreover, the causes of the smell, e.g. the microorganisms in the interior, cannot be combated in this way.

U.S. Patent Application Publication No. 2010/0237649 A1 has disclosed an additional air extraction system and a solar power supply system for the operation of an additional fan when the vehicle is stationary in order to sterilize and cool a vehicle cabin; it also discloses spraying a sterilizing agent into an air duct of a ventilating system. However, this is associated with a considerable outlay without reliably avoiding the sensation of an unpleasant smell upon entry.

According to U.S. Patent Application Publication No. 2006/0079168 A1, the vehicle interior is exposed to a sufficient concentration of ozone to eliminate microorganisms by an ozone generator associated with the heating, ventilation and air-conditioning system (HVAC). In this case, the ozone concentration is measured by a sensor, and the ozone generator is controlled in such a way that an unwanted ozone concentration in the interior is avoided. At the same time, the ozone concentration is not always sufficient to eliminate the microorganisms; moreover, an unpleasant smell, possibly even due to the ozone concentration itself, cannot reliably be avoided.

It is therefore desirable to provide for a process and an apparatus for improving the quality of the air in a vehicle interior in which the abovementioned disadvantages are avoided or at least reduced.

### SUMMARY OF THE INVENTION

According to one aspect of the present invention, a process for improving quality of air in an interior of a vehicle is provided. The process includes the step of activating an air cleaning device during a parked state of the vehicle. The process also includes the steps of providing a signal indicative of ending the parked state of the vehicle and activating an air freshening device based on the signal.

According to another aspect of the present invention, an apparatus is provided for improving quality of air in a vehicle interior. The apparatus includes an air cleaning device, an air freshening device, and a control unit. The control unit is designed for controlling the air cleaning device and the air freshening device in accordance with the process.

According to a further aspect of the present invention, an apparatus for improving quality of air in an interior of a vehicle is provided. The apparatus includes an air cleaning device, an air freshening device, and a control unit. The control unit controls the air cleaning device and the air freshening device. The control unit activates the air cleaning device during a parked state of the vehicle and activates the air freshening device based on a signal for ending the parked state.

These and other aspects, objects, and features of the present invention will be understood and appreciated by those skilled in the art upon studying the following specification, claims, and appended drawings.

### BRIEF DESCRIPTION OF THE DRAWING

In the drawing:

FIG. 1 is a block/flow diagram illustrating a sequence for improving air quality in a vehicle interior, in accordance with one embodiment.

### DETAILED DESCRIPTION OF THE PREFERRED EMBODIMENTS

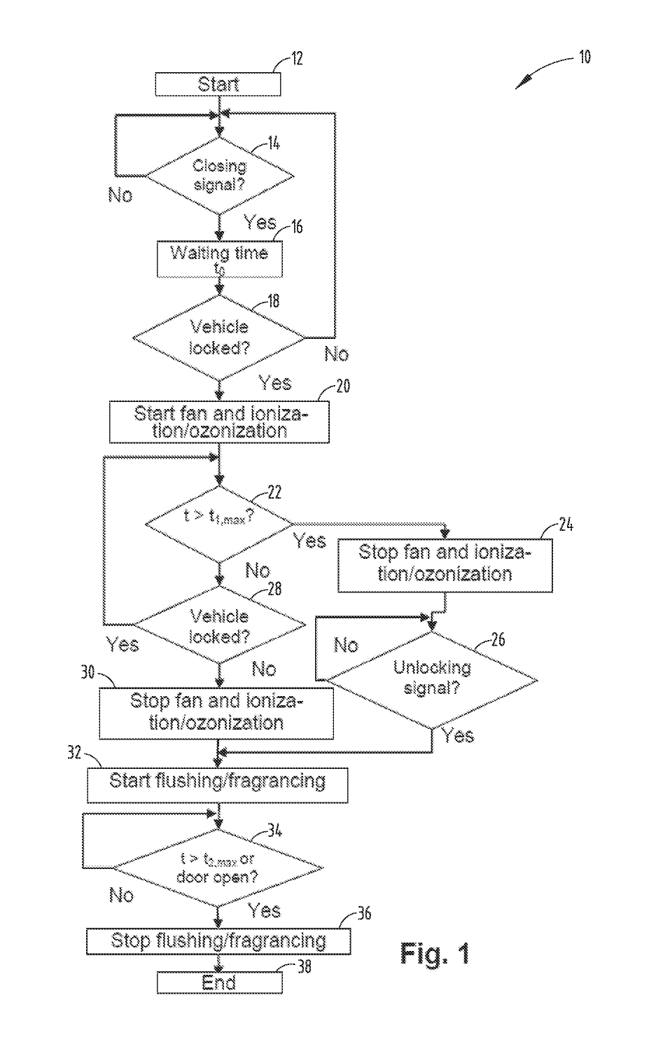

Further details, features and advantages of the invention emerge from the description below of an exemplary embodiment with reference to FIG. 1, in which a view is schematically shown for a process for improving the quality of air in a vehicle interior.

Referring to FIG. 1, a process 10 for air quality improvement in a vehicle interior is shown, according to one embodiment. The process 10 can be started at step 12 manually by a user, in particular by the driver of the vehicle, e.g. by operating a corresponding control element. However, the process can also be started automatically, at predeterminable intervals or each time the vehicle is parked, for instance.

Another start condition used is the closing of the vehicle, which can be detected by the reception of a closing signal. The closing signal can, for example, be a closing signal which is generated by a remote control when a user presses a button, or can be generated in some other way, e.g. in the case of keyless access control, by the driver moving away from the vehicle or, alternatively, by time expiry. As a start condition, it is likewise possible to use a locking signal on the basis of which the doors of the vehicle are locked; this can coincide with the closing signal but can also be generated by a closing system of the vehicle after the reception of a closing signal, for example, when all the doors of the vehicle have been closed. In the process 10 illustrated in FIG. 1, a cyclical interrogation is used to determine whether a closing or locking signal has been received or whether the vehicle has been locked and it can thus be assumed that it is in the parked state.

If a closing signal has been detected at decision step 14, an initial time delay or waiting time t₀ is first allowed to expire at step 16. In particular, a time between 0 and several hours can be set as a waiting time. It is thereby possible to choose the start of the cleaning process in such a way that the ionization or ozonization is not ended too long before the expected ending of the parked state, and therefore the time period during which unwanted constituents can re-accumulate in the interior air is not too long. It would also be possible to specify a fixed waiting time. During the waiting time, a signal, e.g. an intermittent colored light signal, can be displayed on an indication device, allowing the user to see that and, if appropriate, when the cleaning process will start.

After the expiry of the waiting time or initial time delay t₀, another interrogation is used at decision step 18 to determine whether the vehicle is still locked. The initial time delay is thus not restarted if the vehicle has been temporarily unlocked or opened during the waiting time, in order to place a parking ticket in the vehicle, for example. It would also be possible for a cyclical interrogation to take place instead; in this case, the initial time delay is restarted after each closing signal. If the vehicle is put into operation before the expiry of the waiting time, e.g. by starting the engine, the process is aborted in all cases (not shown in FIG. 1).

If the vehicle is still locked after the expiry of the waiting time or initial time delay t₀, air cleaning starts at step 20. For this purpose, a ventilation device having at least one fan is started in order to generate a small ventilation volume flow, preferably with filtered outside air. An ionization generator is furthermore activated, and the ionized air is fed to the vehicle interior by means of the ventilation volume flow. As an alternative or in addition to ionization, an ozone generator can be activated in order to enrich the air in the vehicle interior with the ozone generated. The ionization or ozonization makes it possible to break down outgases or fumes and to combat germs and other organisms. Moreover, the decomposition products which arise are carried away to the exterior by an appropriate volume flow. During ionization or ozonization, a signal, e.g. a flashing light signal, can be displayed on an indication device to indicate that the cleaning cycle is running.

After the expiry of a first maximum time period t_{1,max} determined at decision step 22, but at the latest when the vehicle is unlocked or opened as determined at step 28, the ionization or ozone generator is deactivated, and the fan is no longer operated either at step 24 or step 30. The maximum time period t_{1,max} for the cleaning process can be selectable by the user but is preferably predetermined in accordance with the respective vehicle type and the devices for ionization or ozonization and the ventilating devices in the vehicle. The maximum time period t_{1,max} is typically of the order of hours.

During the cleaning process, there is a cyclical interrogation to determine whether the vehicle is still locked at step 26 or 28. If this is not the case, the cleaning process is aborted and flushing or fragrancing is started at step 36. If, on the other hand, the cleaning cycle ends due to time expiry, flushing or fragrancing is started owing to the reception of an unlocking signal. Once the maximum time period for the cleaning process t_{1,max} been exceeded, a signal, e.g. a permanent light signal, can be displayed on the indication device to indicate that the cleaning cycle is ended.

Flushing is accomplished by operating the ventilating device at a high ventilation volume flow, preferably with filtered outside air, in order to remove fumes or outgases and decomposition products. At the same time as or toward the end of flushing, fragrancing can be performed in order to give the interior of the vehicle a fresh smell before the doors are opened. For this purpose, a fragrance can be introduced, e.g. sprayed, into the ventilation volume flow from a fragrance container. It is also possible for a plurality of fragrance containers to be provided, in which case a personalized fragrance is then used if different drivers can be detected on the basis of the remote control or by a keyless access control device.

Flushing or fragrancing is ended at step 36 either by time expiry after the expiry of a second maximum time period t_{2,max} or by opening a door as determined by decision step 34. The time t_{2,max} is preferably a predetermined time period dependent on the vehicle type and the respective ventilating or fragrancing devices, typically of the order of several seconds. This time period also corresponds approximately to the time period which generally passes between the reception of the unlocking signal and the opening of a door, the unlocking signal being generated, for example, on the basis of actuation of a remote control or by keyless access control on the basis of the driver approaching the vehicle. The ventilation volume flow and the time period t_{2,max} are matched to one another in such a way that a considerable proportion or virtually the entire air volume of the interior is exchanged during the time period t_{2,max}. It is thereby possible to ensure that there are no unpleasant smells noticeable to occupants when getting into the vehicle. The process 10 ends at step 38.

In the process for improving the quality of the air in a vehicle interior, an air cleaning device is activated during a parked state of the vehicle. In particular, an air cleaning device of this kind includes a ventilation system of the vehicle interior, to which means for cleaning the air are assigned. In particular, such means for cleaning the air can comprise a filter for filtering the air in the vehicle interior and/or an air ionization and/or ozonization device. Both ionization and ozonization of the air are suitable means of killing the germs adhering to the surfaces of the interior and of breaking down hydrocarbon compounds gassing out of the surfaces by means of chemical reactions. However, other air cleaning processes can also be employed. The air cleaning device can be activated over the entire time period for which the vehicle is parked or over only part of this time period.

Further in the process, an air freshening device is activated on the basis of a signal for ending the parked state. If such a signal for ending the parked state is detected, it is to be expected that the doors of the vehicle will shortly be opened and that the occupants will get in. To ensure that any unpleasant smell that might be caused by the operation of the air cleaning device is not noticed or not found to be troublesome by the occupants, the air freshening device is thus activated a short time or immediately before the occupants get into the vehicle. In the case where the air cleaning device has not been activated until shortly before the ending of the parked state, it is likewise possible to eliminate any unpleasant smell generated, for example, by renewed outgassing from the interior surfaces. The air freshening device can comprise an air exchange device and/or a fragrancing device, for example, whereby the interior air is exchanged or any remaining smells are no longer noticeable owing to a fragrance supplied.

By virtue of the fact that the air cleaning device is activated during a parked state of the vehicle, and the air freshening device is activated on the basis of a signal for ending the parked state, it is possible to ensure that the causes of unpleasant smells can be combated effectively during the parked state and that the occupants encounter freshened interior air, in which there is no unpleasant smell, when they get into the vehicle.

According to one embodiment, the parked state is detected from the locking and/or closing of the doors of the vehicle and/or from the leaving of the vehicle by the occupants. The locking of the doors can be detected by means of a locking signal or the closing of the doors can be detected by means of door sensors, for example, while the leaving of the vehicle by the occupants can be ascertained on the basis of the signals from occupation sensors of the vehicle seats, for instance. In this way, it is possible to ensure that cleaning of the interior air takes place in the time during which the vehicle is parked and not occupied.

The air cleaning device may be activated with a delay, i.e. after a predeterminable time delay or waiting time after the detection of the start of the parked state. In this way, the start of air cleaning can be set in such a way that it is ended at as short as possible a time before the vehicle is restarted. This avoids a situation where unwanted constituents re-accumulate in the interior air in the time after the ending of cleaning. Provision can also be made for setting of the time delay for the start of air cleaning to take place through a facility for user input of a time for the anticipated restarting of the vehicle, from which an initial time delay after which air cleaning starts is calculated automatically, allowing for an ON duration.

The air cleaning device may be deactivated after a predeterminable ON duration. In particular, the ON duration can be such that the causes of bad smells can be combated effectively. By limiting the ON duration, it is possible to achieve battery-saving operation and reliably to avoid discharge of the vehicle battery even when parking for a prolonged period.

However, it is also possible for the air cleaning device to be deactivated by the signal for ending the parked state. It is thereby possible to ensure that the air cleaning device is in operation until just before the occupants get in and that, as a result, a maximum cleaning effect is achieved.

The air cleaning device may be deactivated after a predeterminable ON duration unless a signal for ending the parked state is received within the ON duration. In all cases, however, the air cleaning device is deactivated at the latest on the basis of the signal for ending the parked state according to one embodiment. This makes it possible to ensure a sufficient cleaning effect while simultaneously sparing the vehicle battery and to avoid troubling the occupants by the cleaning operation.

According to one embodiment, the signal for ending the parked state is a signal for unlocking the doors of the vehicle. Since the unlocking button of a remote control is often pressed or a keyless access control device detects the approach of the driver several seconds before the doors of the vehicle are opened, there is sufficient time between the reception of the signal for unlocking the doors of the vehicle and the opening of the doors or entry of the occupants to the vehicle to create a pleasant atmosphere for the occupants in the interior by activating the air freshening device.

In one embodiment, the air freshening device may be deactivated due to the opening of a door of the vehicle. In this case, the operation of the air freshening device, which can be associated with high-speed and therefore noisy operation of fans, is virtually imperceptible to the occupants of the vehicle.

An apparatus for improving the quality of the air in a vehicle interior includes an air cleaning device, an air freshening device and a control unit, wherein the control unit is designed for controlling the air cleaning device and the air freshening device in accordance with the process described above. An apparatus is thereby created which allows efficient combating of the causes of unpleasant smells in a vehicle interior without imposing stress on the occupants by the cleaning operation.

According to one embodiment of the apparatus, the air cleaning device comprises a ventilation system for the vehicle interior, to which means for cleaning the air are assigned. The ventilation system can be designed as a heating, ventilation and air-conditioning system (HVAC), for instance, or, alternatively, as a separate fan with corresponding air ducts. The ventilation system can be designed both for an air admission and for an air recirculation mode.

In particular, such means for cleaning the air can comprise a filter for filtering the air in the vehicle interior, it being possible for filtering to take place both in the air recirculation mode and in the air admission mode and to comprise either gas or particle filtering or both. It is thereby possible to filter the air contained in the vehicle interior or to replace it with filtered outside air.

In one embodiment, the means for cleaning the air includes an air ionization device, which interacts with the ventilation system in such a way that the interior of the vehicle can be supplied with ionized air. Air ionization devices are known per se; in this regard, reference is made to DE 103 17 514 B3. The air ionization device can introduce positive and/or negative ions into a ventilation air stream. As an alternative or in addition, the means for cleaning the air can comprise an ozonization device, by means of which the interior air is enriched with ozone. Apparatuses for generating ozone are known per se, e.g. from U.S. Pat. No. 7,407,624 B2. In particular, the ozonization device can be designed as an ozone generator. The air ionization device or ozone generator is preferably arranged at an air outlet of the heating, ventilation and air-conditioning system (HVAC), but can also be arranged at a separate air duct. Both ionization and ozonization of the interior air are suitable means of killing the germs adhering to the surfaces of the interior and, by means of chemical reactions, for converting hydrocarbon compounds gassing out of the surfaces into compounds which are harmless or cannot be detected from the smell thereof.

The air freshening device can advantageously be designed as an air exchange device including, for instance, a ventilation system which can be operated in air admission mode. In particular, the ventilation system is designed in such a way that virtually all the air in the interior can be exchanged within a short time, namely between the reception of the signal for ending the parked state and the entry of the occupants. Upon getting in, therefore, the occupants can no longer detect the ozone generated by the air cleaning device, for example.

As an alternative or in addition, the air freshening device can be designed as a fragrancing device, which comprises a ventilation system, a fragrance holder assigned to the ventilation system, and a fragrance feed, for example. With the aid of the fragrance feed, fragrance stored in the fragrance holder can be fed into the interior air, it being possible, for example, for the fragrance to be sprayed into a ventilating outlet of the ventilation system. The ventilation system has an air admission and/or air recirculation circuit, allowing the fragrance to be fed into fresh air supplied and/or into the recirculated inside air. Effective feeding of the fragrance to the interior air is thereby ensured and, as a result, any residual smells are no longer noticeable.

Furthermore, the air cleaning device and the air freshening device may be integrated into a ventilating device of the vehicle, in particular into an HVAC system. One advantageous possibility, by way of example is to arrange an ionization or ozonization device and the fragrance feed of a fragrancing device in an air duct close to an air exit opening, preferably in an air duct of an air exit opening arranged to blow air toward an occupant; arrangement in several air ducts or close to several air exit openings is also advantageous. This allows a cost-saving and effective embodiment of the apparatus according to the invention.

However, it is also possible for the air cleaning device and/or air freshening device to be designed with or for retrofitting with a fan provided in addition to the HVAC system. In the latter case, both the air cleaning device and the air freshening device can be fitted with an air recirculation device and be designed to be mounted in a central location within the vehicle interior. In this case, the air cleaning device and the air freshening device can be designed as separate modules, each with dedicated air recirculation, for example.

The control unit can be the control unit of an HVAC system, but can also be designed as a separate controller. In the case where the apparatus for improving the interior air is designed for retrofitting, a separate controller is preferred. The control unit can have operating elements, e.g. for starting the process for improving the quality of the interior air or for setting the time delay of the cleaning operation after the start of parking, and can also have indicating elements.

According to one embodiment, a status indicator for indicating a status of an air quality improvement operation is provided. This enables a driver of the vehicle to see at any time whether and to what extent an air quality improvement operation in accordance with a process, in particular an air cleaning operation, has been carried out and whether an additional cleaning operation must be initiated manually, for example.

The process and apparatus can be employed in motor cars, in particular, but also in commercial vehicles and other vehicles which have a substantially enclosed interior in which the vehicle occupants remain while traveling.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A process for improving quality of air in an interior of a vehicle, comprising:
activating an air cleaning device during a parked state of the vehicle;
providing a signal indicative of ending the parked state of the vehicle; and
activating an air freshening device based on the signal.

2. The process as claimed in claim 1 further comprising detecting the parked state from one of locking and closing of vehicle doors.

3. The process as claimed in claim 1 further comprising detecting the parked state from leaving of the vehicle by one or more occupants.

4. The process as claimed in claim 1, wherein the step of activating the air cleaning device comprises activating the air cleaning device with a predetermined time delay tₒ after detecting the parked state.

5. The process as claimed in claim 1 further comprising deactivating the air cleaning device after a predetermined ON duration.

6. The process as claimed in claim 1 further comprising deactivating the air cleaning device based on the signal for ending the parked state.

7. The process as claimed in claim 1, wherein the signal is a signal for unlocking the doors of the vehicle.

8. The process as claimed in claim 1 further comprising a step of deactivating the air freshening device due to opening of a door of the vehicle.

9. An apparatus for improving quality of air in a vehicle interior, comprising an air cleaning device, an air freshening device and a control unit, wherein the control unit is designed for controlling the air cleaning device and the air freshening device in accordance with a process as claimed in claim 1.

10. An apparatus for improving quality of air in an interior of a vehicle, comprising:
an air cleaning device;
an air freshening device; and
a control unit for controlling the air cleaning device and the air freshening device, wherein the control unit activates the air cleaning device during a parked state of the vehicle and activates the air freshening device based on a signal for ending the parked state.

11. The apparatus as claimed in claim 10, wherein the air cleaning device comprises a ventilation system and filtering, and at least one of an air ionization and ozonization device interacting with the ventilation system.

12. The apparatus as claimed in claim 10, wherein the air freshening device comprises a ventilation system having an air admission circuit.

13. The apparatus as claimed in claim 10, wherein the air freshening system comprises a ventilation system having at least one of an air admission and an air recirculation circuit.

14. The apparatus as claimed in claim 13, wherein the air freshening system further comprises a fragrance holder and a fragrance feed

15. The apparatus as claimed in claim 10, wherein the air cleaning device and the air freshening device are integrated into a ventilating device of the vehicle.

16. The apparatus as claimed in claim 10, wherein the at least one of the air cleaning device and the air freshening device are designed for retrofitting.

17. The apparatus as claimed in claim 10 further comprising a status indicator for indicating a status of an air quality improvement operation.
